(19) United States
(12) Patent Application Publication
(10) Pub. No.: US 2013/0189946 A1
(43) Pub. Date: Jul. 25, 2013

(54) Security System Alarming and Processing Based on User Location Information

(71) Applicant: NUMEREX CORP., Atlanta, GA (US)

(72) Inventor: Dean Stewart Swanson, Alpharetta, GA (US)

(73) Assignee: NUMEREX CORP., Atlanta, GA (US)

(21) Appl. No.: 13/744,510

(22) Filed: Jan. 18, 2013

Related U.S. Application Data
(60) Provisional application No. 61/588,211, filed on Jan. 19, 2012.

(51) Int. Cl. H04W 64/00

(52) U.S. Cl. CPC H04W 64/006
USPC 455/404.2

(57) ABSTRACT

A system and method for monitoring an alarm system at a premises is described. The alarm system includes sensors to detect one or more alarm conditions at the premises. In response to an alarm condition, an alarm signal is sent to a gateway. In response to the alarm, the gateway retrieves location of associated users of the alarm system and location of the premises and sends the alarm condition and the location information to a monitoring center which receives the locations of the associated users of the alarm system and the location of the premises from the gateway and determines a response to the alarm based on the locations of the associated users.

### CROSS REFERENCE TO RELATED INFORMATION

This application claims the benefit of U.S. Provisional Patent Application No. 61/588,211, filed Jan. 19, 2012, the contents of which are hereby incorporated herein in its entirety.

### TECHNICAL FIELD

The present disclosure is directed to premises alarm systems, and more particularly to premises alarm systems that incorporate location information for registered users.

### BACKGROUND OF THE INVENTION

Currently, at the time of an alarm or other security event communicated by a security system, the central monitoring station does not automatically know the location of the customers using the monitored facility. The central station usually contacts the customer(s) by phone (landline or wireless) to determine their location and validate the alarm. This is the only method that the central station has to determine whether the customer is at the monitored facility (e.g., in specific danger, or responsible for a false alarm) or whether the facility is not occupied at the time of the alarm. The central station can determine this only for customers that it can contact directly by phone in real time, and the status of other potential occupants cannot be determined.

The other method by which a security system can communicate with the cellular phone of a security system customer is to automatically send the alarm notification to the customer's cell phone using a text message (usually) or an email. This message is sent irrespective of the customer's location, and no customer location information is collected or communicated during this notification.

### BRIEF SUMMARY OF THE INVENTION

In a preferred embodiment, an alarm system at the premises is described. The alarm system includes sensors to detect one or more alarm conditions at the premises and a gateway operable to receive an alarm from the alarm system in response to an alarm condition. In response to the alarm, the gateway retrieves location of associated users of the alarm system and location of the premises, and sends the information to a monitoring center monitoring the alarm system. The monitoring system receives the locations of the associated users of the alarm system and the location of the premises from the gateway and determines a response to the alarm based on the locations of the associated users.

In another preferred embodiment, a method of responding to an alarm at a premises is described. The method includes detecting the activation of an alarm in response to one or more alarm conditions. The location information for users associated with the premises is retrieved, and a response to the alarm is determined based on the alarm conditions and the locations of the users associated with the premises.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a network diagram of a traditional monitored premises alarm system;

FIG. 2 is a network diagram of a preferred embodiment of a premises alarm system that utilizes user location according to the concepts described herein; and

FIG. 3 is a flow chart of a preferred embodiment of a method of using user location in a premises alarm system according to the concepts described herein.

### DETAILED DESCRIPTION OF THE INVENTION

In a traditional home or business security system, an alarm can be triggered by motion sensors, door or window sensors, under carpet sensors, smoke detectors or depressing an alarm button on a keypad. The security system then signals to a central station that acts as an ‘Emergency Monitoring and Dispatch Center’ that an alarm condition has occurred and may also email, SMS or call the individual owner as well with the alert. The central station often is the source for notifying the police, fire, e-911 center or ambulance service.

However, the central station has no information regarding the location of the individuals living in the house or working at the business and cannot make informed decisions regarding the severity of the alert and the impact based on if the individuals are at the premises of interest or away.

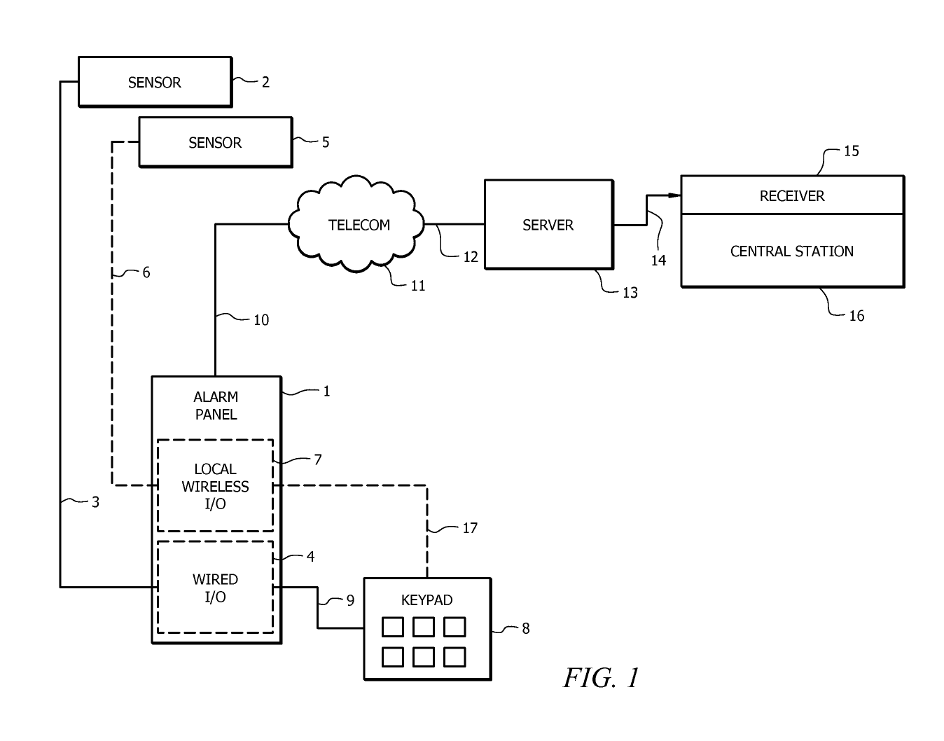

FIG. 1 illustrates a typical legacy security alarm system as currently practiced. The premises' security alarm system controller (referred to as the “alarm panel”) 1 possesses two interfaces for interfacing sensors 2, 5 and keypad(s) 8. Sensor 2 is connected via wire 3 to the wired sensor input/output 4 of alarm panel 1. Sensor 5 is connected via short-range radio signal 6 to the wireless sensor input/output 7 of alarm panel 1. When an event triggers sensor 2 it alters electrical connectivity through wires 3 to the wired sensor input/output 4 of alarm panel 1 so as to stimulate a report of the event. Similarly, when an event triggers sensor 5 it transmits a data packet short-range radio signal 6 to the wireless sensor input/output 7 of alarm panel 1 so as to store a report of the event. Sensor 5 can be any type of typical alarm sensor, such as a contact sensor, motion sensor, glass break sensor or the like or can also be other types of alarm inputs such as cameras, video or still, infrared, alert buttons or any other useful alarm input capable of triggering in the event of an alarm condition.

Keypad 8 enables a user at or near the premises to enter a predetermined code that, if correct, causes keypad 8 to send a signal over the two-way wired keypad bus 9 to alarm panel 1 via the sired sensor input/output 4 to instruct alarm panel 1 of the user's response to that particular event signal, such as canceling or ignoring an event. Alternatively, in some installations keypad 8 interfaces with alarm panel 1 with a short range radio signal 17 via local wireless I/O 7 with functionality being the same as described above.

Alarm panel 1, upon receipt of an event detected by a sensor 2 and/or 5, transmits an alarm signal to server 13 via public telecommunications channel 10 hosted by telecommunications service provider 11, which can be a wired telephone line but, in some cases, will be wireless telecommunications using cellular telephony, Short Message Service (SMS) or TCP/IP over either public cellular telecommunications data channels, such as GPRS, CDMA or LTE, or wired networks, such as T1, ADSL or VoIP. The communications path 12 from telecommunications service provider 11 to server 13 can be any type of connection, but is most often a dial-up or dedicated wireline telephone circuit provided by, telecommunications service provider 11. It may also be wireless telecommunications using cellular telephony, Short Message Service (SMS) or TCP/IP over either public cellular telecommunications data channels, such as GPRS, CDMA or LTE, or wired networks, such as T1, ADSL or VoIP. Once the event is received by server 13 the identity of alarm panel 1 is used to query a database of server 13 to determine which central station 16 is to receive the event report and what communications path and protocol should be used. After making this determination, server 13 transmits the event data to alarm receiver 15, which is a part of central station 16, via communications circuit 14.

When central station 16 receives the reported event data it takes action based upon predetermined criteria which may include alerting police or fire departments, as appropriate to the type of event. In addition to the above described transmission of event data from alarm panel 1 to server 13 and ultimately central station 16, alarm panel 1 also sends a version of the same event data to keypad 8, in most cases simultaneously but in some cases prior to sending it to server 13 and ultimately central station 16 so as to provide a user at the premises to cancel the event transmissions, such as when the user enters the premises via a door identified in the database of alarm panel 1 as a delayed action sensor.

As described above, one impediment to central station 16 is the lack of visibility into the location of the residents or users of the premises being monitored in the case of an alarm condition. Without this information, the central station is limited to calling emergency responders and one or more of a list of designated contacts for the alarm being monitored. If central station 16 had information on current location, it could target its contact protocol for the type of alarm and the relative location of the individuals associated with the premises.

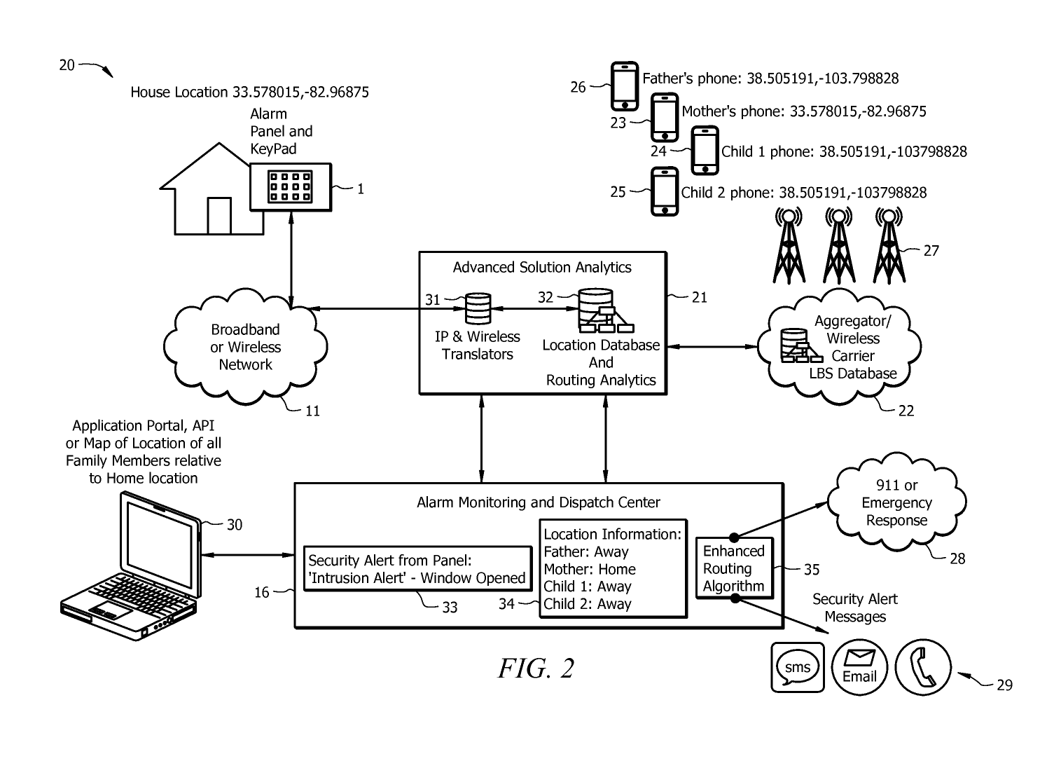

Referring now to FIG. 2, an embodiment of a premises alarm system that utilizes location information on individuals associated with the alarm is described. The alarm system 20, incorporating the concepts described herein, enhances security systems by overlaying the security alarm system alert with the approximate location of family members or employees (whether at the premises or away). They can be displayed as a map with the location information or as just the raw information based on geo-fencing its to whether a person is inside the premises or not, and/or their relative location to the premises.

Alarm system 20 includes premises alarm 1 which communicates with a central station 16 over a telecom network 11. Alarm system 20 adds an advanced solution center 21 to the traditional premises alarm system. In addition to other functionality, advanced solution center 21 communicates with various systems using translators 31 and maintains a location database 32 for the users of all monitored alarm systems.

The location of the family members or employees can be based upon the location of their individual cell phones 23, 24, 25 and 26 with the location information derived from a client application on the cellular phone, from the cellular network provider or from an aggregator of cellular Location Based Service (LBS) information 22. The location information normally includes the latitude and longitude coordinates for the device and/or cell tower area and is normally accurate within 30 to 2000 meters of accuracy. The LBS data may be derived from a single cell tower's operation radius, multiple cell tower triangulation 27, cellular switch center location, GPS polling or other techniques and may be combined with consumer cell phone LBS location records to enhance the accuracy of the location coordinates. It should be noted that this information can be obtained anonymously from the cell phone without the cellular subscriber having to participate or be aware that its location is being determined as well as being obtained from consumers who have ‘opted-in’ to meet privacy requirements. The information can be obtained as long as the phone is powered on and registered with the cellular network, even if the subscriber is conducting a call at the time.

Embodiments of present system could use the previously registered location of the house or business and the previously registered Mobile Directory Number of each person of interest, such as the family members or one or more employees. With this information, advanced solution center 21 can then create a geo-fence (a defined radius around the perimeter of the home address, business address or other fixed point and/or around the consumer's cell phone) based on the location of the premises or individual. Location information from the consumer's cell phone or a query into an LBS database at any time will return the location of each of the person of interest's cell phone and this information can be compared with the geo-fence of the premises to determine who may be inside the premises at the time of an alarm condition. Alternatively, the system could present the central station with a map showing the location of the alarm and the relative location of the family members or employees.

With this additional information, an algorithmic analytic engine, according to the concepts described herein, can calculate the severity of the alert in terms of life threatening conditions and whether it is likely a ‘false alarm’ or a ‘real emergency’ by using the LBS information. (For example, notification to the police would be different for an intrusion alarm if customers are at the facility rather than all being outside the facility; or notification to the fire department would be different for a fire alarm if customers are at the facility.) It could also be used to determine how close to home a family member may be at the time of an alarm to determine whom to notify first or whom to call first.

Still referring to FIG. 2, alarm 1 communicates over a network 11 using IP, SMS, GPRS, CDMA, LTE or other technologies and transmits data containing the alarm data. The provider first receives the data at advanced solutions center 21 and translates the data using translators 31. Routing and analytics are provided based on the data. The provider pulls the latitude and longitude coordinates of each cell phone associated with the security system from phone or a location database 21, which has been populated from carrier LBS services 22. Next, the provider sends the alarm messaging to a security alert window 33 at dispatch center 16 and sends the cell phone locations to location function 34 at dispatch center 16. The dispatch center then has the option to use the data for additional routing by routing algorithm 35 based on the combination of data (alarm data and location information), this routing could be to emergency services 28 or registered family, employees, friends or other users using communications techniques 29, such as SMS, email or phone. An application portal 30 allows registered users to log in and see alarm conditions or to change user information or profiles.

Preferred embodiments of this service may require the customers to ‘opt-in’ for each participating cell phone to allow the security company to use the location information derived from the cell phone in order to avoid privacy issues and also comply with FCC regulations.

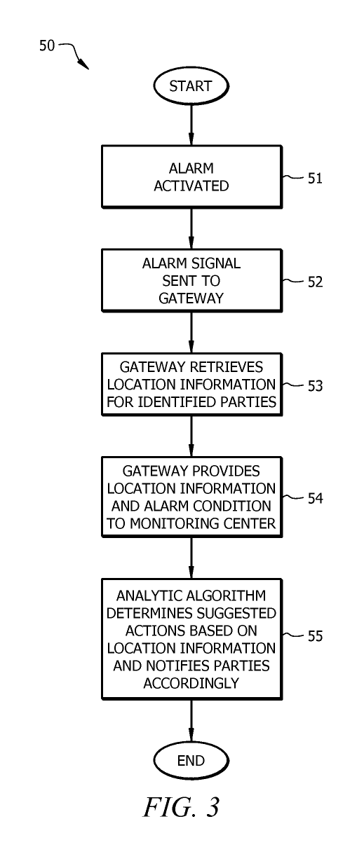

Referring now to FIG. 3, an embodiment of a method for using location information with an alarm system is described. Method 50 begins with the activation of a monitored alarm system 51. The alarm signal is sent from the monitored premises to the gateway, or advanced solutions center, as shown in block 52. As described with reference to FIG. 2, the advanced solutions center sits between the alarm system and the central monitoring station or dispatch center. At this location, the advanced solutions center is able to maintain a real-time database of user location or is able to retrieve user location from the cell phone or carrier location based services for registered users associated with the alarm. The registered users can be family members, employees or other interested parties.

Once the alarm signal is received, the location of the registered users is pulled and analyzed by the advanced solutions center. The analysis can be a comparison to a geofence, can be relative distance from the alarm premises, plotting user location against the premises location, or can be any other useful format for the information. This information is passed to the monitoring center in block 54 where it is analyzed for response in block 55 based on various factors, such as the type of alarm and location of the users. Based on the analysis, the monitoring center can take an informed action and contact one or more of the users based on location and/or notify emergency services.

While certain mechanisms for determining, collecting and reporting associated user location have been described, any mechanism for gathering location information to provide to the central station could be used including methods utilizing the alarm panel, the central station, various query mechanisms or other methods may be used. For example, the alarm panel or device in the premises could be used by querying the phone location source over a network connection upon an event. For locations within the premises short range technologies such as NFC, Bluetooth, Zigbee, Zwave, etc. can be used where the phone transmits its location upon trigger using the short range radio technology in the premises. When using short range wireless to transmit the location information it is assumed a native application will reside on the cell phone. In the absence of a positive response over the short range network, the emergency response database could use the last known LBS address on file or from the network LBS provided coordinates.

The central station could query the phone location source over a network connection upon an event, or responding authorities could query the phone location source over a network connection upon an event. Other possibilities include Intermediate Phone Location services (PLaaS) that supplies the location upon a request from any of the above device/entities, supplies the location as it is processing other event signals, or can query any involved devices (like smart phone or GPS device) for the location as well as get the location from carriers.

Other types of technologies other than cell-based location mechanisms can also be used to enhance the solution via analytics using location from other sources to include but not limited to: cell phone locations via GPS, vehicle locations via GPS enabled vehicles, asset location via GPS enabled devices, Pet location via GPS enabled devices, Internet-based location or other such mechanisms.

While the described embodiments utilize the alarm system to maintain location information, carriers or other third party providers could be used to send location information in response to a request at the time of an alarm condition. Additionally, instead of the requester sending multiple phone numbers to be located, a database of associated users could be maintained by a service provider so the alarm system would send just one identifier code to the service provider to get all locations of associated users. On smart-phones, an application on the phone could be used to report a more accurate location than the cell network location. The application could be also used to allow the user to positively indicate when they are with the phone.

The concepts described herein may be implemented by an alarm monitoring company that communicates directly with cellular carriers to determine the location of customer cell phones. It could also be implemented by a third party service provider or aggregator that provides a service to multiple alarm monitoring companies, and which communicates with several cellular carriers to obtain the location of customer cell phones. Other implementations could be easily envisioned by one skilled in the art without departing from the scope of the concepts described herein.

In addition, individual elements of the system can be implemented by different entities. For example, the algorithmic logic to compare customer cell phone locations to the location of monitored premises could be implemented by the alarm monitoring company, by a third party service provider or by another entity. Similarly, the algorithmic logic to determine the severity of an alarm situation, and to determine notification strategies or procedures, could be implemented by the alarm monitoring company, by a third party service provider or by another entity. The algorithmic logic to automatically send notifications to customers or additional recipients based on the results of the previous analyses could also be implemented by the alarm monitoring company, by a third party service provider or by another entity.

With the advent and deployment of short-range wireless technologies including but not limited to Bluetooth and Zigbee, it is further envisioned that some home security gateway solutions and devices, sensors, etc. may also be able to take advantage of the advanced routing capability from this invention and communicate alerts, location information, etc. to various devices connected to the overall solution via short range wireless technology.

This invention could be used for both residential security monitoring and/or security monitoring of businesses or other premises. For residential security monitoring, registered (“opt-in”) cell phones could be included for anyone who has access to the house and probably knows the security code for the monitoring system, such as maids and nannies. For commercial security monitoring, registered cell phones could include all employees, or just employees or contractors who are likely to access a facility at off-hours when the monitoring system would be armed, such as security guards, janitors, employees who work late or work off-peak shifts.

The concepts described herein deliver significant value-add to the dispatch centers and emergency response units that utilize the solution. For example, clearly if a home fire alert is received but the solution determines all family member locations are away from the home, the fire department can be alerted early and it may aid in their decision to enter the house or not enter under dangerous conditions, etc. If, however, a fire alarm alert is received and the solution determines one or more family members location are in the house, the fire department can be notified immediately of the chance a family member is in the home and may need to be rescued. In terms of traditional security alerts, many times as family member inadvertently sets off as home alarm when they forget to disarm the system before entering. In this case, if a dispatch center gets an invasion alarm and the location of one or more family members are at the home, they can notify the police and/or other family members accordingly. This information could also be used in the alert algorithm to decide whether to utilize a voice connection to the home security panel/gateway to request if the homeowner is home and/or confirm the false alarm.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for monitoring a premises comprising,
an alarm system at the premises, the alarm system including sensors to detect one or more alarm conditions at the premises;
a gateway operable to receive an alarm from the alarm system in response to an alarm condition, wherein, in response to the alarm, the gateway retrieves location of associated users of the alarm system and location of the premises; and
a monitoring system monitoring the alarm system wherein the monitoring system receives the locations of the associated users of the alarm system and the location of the premises from the gateway and determines a response to the alarm based on the locations of the associated users and premises location.

2. The system of claim 1 further comprising a location database at the gateway storing the location information.

3. The system of the claim 1 wherein the location information is retrieved from telecom carriers based on the telecom carrier's location based services.

4. The system of the claim 1 wherein the location information is retrieved from a client application on the user's cell phone.

5. The system of claim 1 wherein the gateway is operable to create a geofence around the premises and monitor the location of each associated user in relation to the geofence.

6. The system of claim 1 wherein the monitoring system determines the response based on the type of alarm condition in addition to the location of the associated users.

7. The system of claim 1 wherein the response includes notifying emergency services.

8. The system of claim 1 wherein the response includes notifying an associated user nearest the premises.

9. The system of claim 1 further comprising a portal usable by the associated users.

10. The system of claim 1 determination of the response by the monitoring center is performed by a routing algorithm, the algorithm utilizing all known locations and rules based analytics customizable for each alarm customer.

11. A method of responding to an alarm at a location, the method comprising:
detecting the activation of an alarm in response to one or more alarm conditions;
retrieving location information for users associated with the premises; and
determining a response to the alarm based on the alarm conditions, the location of the premises and the locations of the users associated with the premises.

12. The method of claim 11 further comprising a location database at the gateway storing the location information.

13. The method of the claim 11 wherein the location information is retrieved from telecom carriers based on the telecom carrier's location based services.

14. The method of the claim 11 wherein the location information is retrieved from a client application on the user's cell phone.

15. The method of claim 11 wherein the gateway is operable to create a geofence around the premises and monitor the location of each associated user in relation to the geofence.

16. The method of claim 11 wherein the monitoring system determines the response based on the type of alarm condition in addition to the location of the associated users.

17. The method of claim 11 wherein the response includes notifying emergency services.

18. The method of claim 11 wherein the response includes notifying an associated user nearest the premises.

19. The method of claim 11 further comprising a portal usable by the associated users.

20. The method of claim 11 determination of the response by the monitoring center is performed by a routing algorithm, the algorithm utilizing all known locations and rules based analytics customizable for each alarm customer.
